(19) United States
(12) Patent Application Publication
(10) Pub. No.: US 2021/0357469 A1
(43) Pub. Date: Nov. 18, 2021

(54) METHOD FOR EVALUATING KNOWLEDGE CONTENT, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Yongheng LI, Beijing (CN); Xiaowan LI, Beijing (CN); Shichen SHAO, Beijing (CN)

(73) Assignee: BEIJING BAIDU NETCOM SCIENCE AND TECHNOLOGY CO., LTD.

(21) Appl. No.: 17/130,279

(22) Filed: Dec. 22, 2020

(30) Foreign Application Priority Data
May 14, 2020 (CN) 202010407510.6

(51) Int. Cl. G06F 16/9535; G06N 20/00

(52) U.S. Cl. CPC G06F 16/9535; G06N 20/00

(57) ABSTRACT

The present disclosure provides a method for evaluating a knowledge content, an electronic device and a storage medium, and relates to a field of knowledge content evaluating technologies. The method includes: obtaining a knowledge content; obtaining an evaluation parameter of the knowledge content, in which the evaluation parameter includes demand intensity information, author authority information, and scarcity degree information of the knowledge content; and generating an evaluation value of the knowledge content according to the evaluation parameter.

### CROSS-REFERENCE TO RELATED APPLICATION

This application is based upon and claims priority to and benefits of Chinese Patent Application Serial No. 202010407510.6, filed the State Intellectual Property Office of P. R. China on May 14, 2020, the entire content of which is incorporated herein by reference.

### TECHNICAL FIELD

The present disclosure relates to a field of computer technologies, and more particular to, a technical field of evaluating a knowledge content.

### BACKGROUND

Generally, in the related art, knowledge content is evaluated by roughly estimating evaluation values of different knowledge contents based on data such as limited survey results and labor costs, or uniformly pricing the knowledge content labeled as the same or similar categories.

### SUMMARY

Embodiments of the present disclosure provide a method for evaluating a knowledge content. The method includes: obtaining knowledge a content; obtaining an evaluation parameter of the knowledge content, in which the evaluation parameter includes demand intensity information, author authority information, and scarcity degree information of the knowledge content; and generating an evaluation value of the knowledge content according to the evaluation parameter.

Embodiments of the present disclosure provide an electronic device. The electronic device includes: at least one processor, and a memory communicatively connected to the at least one processor. The memory stores instructions executable by the at least one processor, and when the instructions are executed by the at least one processor, the at least one processor is caused to implement the method according to above embodiments of the present disclosure.

Embodiments of the present disclosure provide a non-transitory computer-readable storage medium storing computer instructions. When the instructions are executed, the computer is caused to implement the method according to above embodiments of the present disclosure.

It should be understood that the content described in this section is not intended to identify the key or important features of the embodiments of the present disclosure, nor is it intended to limit the scope of the present disclosure. Additional features of the present disclosure will be easily understood by the following description.

### BRIEF DESCRIPTION OF THE DRAWINGS

The drawings are used to better understand the solution and do not constitute a limitation to the present disclosure, in which:

FIG. 1 is a schematic diagram of Embodiment 1 of the present disclosure.

FIG. 2 is a schematic diagram of Embodiment 2 of the present disclosure.

FIG. 3 is a schematic diagram of establishing an evaluation model.

FIG. 4 is a schematic diagram of Embodiment 3 of the present disclosure.

FIG. 5 is a schematic diagram of Embodiment 4 of the present disclosure.

FIG. 6 is a schematic diagram of Embodiment 5 of the present disclosure.

FIG. 7 is a block diagram of an electronic device used to implement the method for evaluating knowledge content according to an embodiment of the present disclosure.

### DETAILED DESCRIPTION

The following describes the exemplary embodiments of the present disclosure with reference to the accompanying drawings, which includes various details of the embodiments of the present disclosure to facilitate understanding, which shall be considered merely exemplary. Therefore, those of ordinary skill in the art should recognize that various changes and modifications can be made to the embodiments described herein without departing from the scope and spirit of the present disclosure. For clarity and conciseness, descriptions of well-known functions and structures are omitted in the following description.

Generally, in the related art, knowledge content is evaluated by roughly estimating evaluation values of different knowledge contents based on data such as limited survey results and labor costs, or uniformly pricing the knowledge content labeled as the same or similar categories.

However, in above process of determining the evaluation value, excessive subjectivity of relevant personnel and lack of reasonable and complete reference system may cause low accuracy, poor rationality, and great deviation of the determined evaluation value of the knowledge content.

Thus, the present disclosure provides a method and an apparatus for evaluating a knowledge content, an electronic device and a storage medium.

A method and an apparatus for evaluating a knowledge content, an electronic device and a storage medium according to the embodiments of the present disclosure are described with reference to the accompanying drawings.

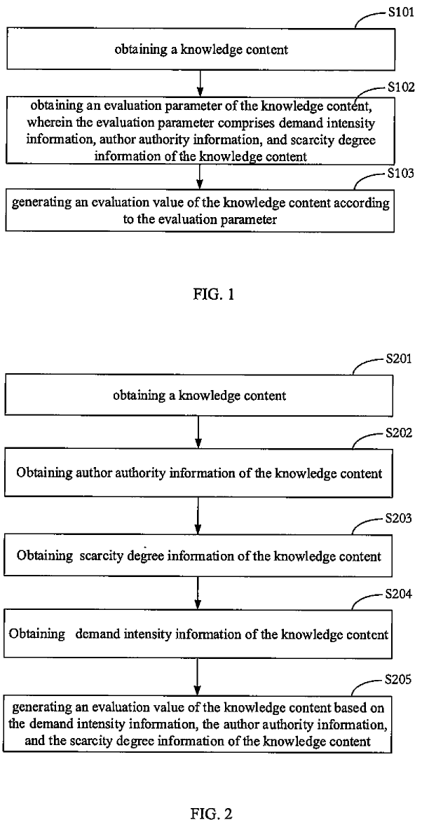

FIG. 1 is a flow chart of Embodiment 1 of the present disclosure. It should be noted that an execution subject of a method for evaluating a knowledge content according to this embodiment is an apparatus for evaluating a knowledge content, which may be a hardware device, or software in a hardware device. For example, the hardware device may include a terminal device, a server. As illustrated in FIG. 1, the method for evaluating a knowledge content according to this embodiment includes the following actions.

At block S101, a knowledge content is obtained.

In an embodiment of the present disclosure, a knowledge content to be priced that needs to be evaluated may be acquired.

The knowledge content may include but is not limited to at least one of a video, an audio, a file, a paid question and answer, a live streaming, and an Audiobook.

For example, if a video about basic teaching in Spanish published by author A has not been priced or needs to be re-priced, the video may be obtained; or, for a paid question published by user B with a value of 5 RMB, a price for an answer to the question has not been determined or needs to be re-determined, then the paid question and answer may be obtained.

At block S102, an evaluation parameter of the knowledge content is obtained, in which the evaluation parameter includes demand intensity information, author authority information, and scarcity degree information of the knowledge content.

It should be noted that the evaluation parameter is a collection of multiple pieces of information related to the knowledge content, that is, the evaluation parameter is a collection of a group of information. Meanwhile, each knowledge content corresponds to a corresponding evaluation parameter, and an information result contained in the evaluation parameter affects an evaluation value of the knowledge content.

The evaluation parameter of the knowledge content at least includes the demand intensity information, the author authority information, and the scarcity degree information of the knowledge content.

At block S103, an evaluation value of the knowledge content is generated according to the evaluation parameter.

In an embodiment of the present disclosure, after obtaining the evaluation parameter of the knowledge content, the evaluation parameter may be input into an evaluation model obtained by training, and then the evaluation model may generate the evaluation value of the knowledge content based on the above information, i.e., the demand intensity information, the author authority information, and the scarcity degree information of the knowledge content.

With the method for evaluating a knowledge content according to the embodiments of the present disclosure, the knowledge content to be evaluated and the evaluation parameter of the knowledge content are acquired, and the evaluation value of the knowledge content is generated according to the evaluation parameter of the knowledge content, which not only avoids the technical problem of excessive subjectivity in evaluating the knowledge content, but also may reduce a deviation of the evaluation value of the knowledge content as much as possible, so that the rationality and accuracy of the evaluation value is improved.

FIG. 2 is a flow chart of Embodiment 2 of the present disclosure. As illustrated in FIG. 2, based on the above embodiment, the method for evaluating a knowledge content includes the following actions.

At block S201, a knowledge content is obtained.

The action at block S201 is the same as the action at block S101 in the above embodiment, which will not be repeated herein.

The action at block S102 according to the above embodiment may include the following actions at blocks S202-S204.

At block S202, author authority information of the knowledge content is obtained.

In an embodiment of the present disclosure, the author authority information of the knowledge content may be obtained by follows. At least one of the number of retrieval times of an author of the knowledge content at a search terminal and the number of followers on a social media of the author of the knowledge content is obtained. The author authority information of the knowledge content is determined according to at least one of the number of the retrieval times and the number of the followers.

It should be noted that, in some embodiments of the present disclosure, a mapping relation between the author authority information of the knowledge content and the number of retrieval times of an author of the knowledge content and/or the number of followers on a social media and may be preset. After the number of retrieval times of the author of the knowledge content and/or the number of followers on the social media is obtained, the author authority information of the knowledge content may be obtained by querying the mapping relation.

For example, when evaluating New Explanation on the Analects of Confucius written by Mr. A and published on a certain thesis database B, the number of retrieval times associated with Mr. A is obtained, and further, an author authority information of Mr. A is determined by querying the mapping relation. In an embodiment of the present disclosure, the number of followers of Mr. A at a social media about the thesis database B is obtained, and then the author authority information of Mr. A is determined by querying the mapping relation. In an embodiment of the present disclosure, both the number of retrieval times associated with Mr. A on the certain thesis database B and the number of followers at the social media about the thesis database B are obtained, and the author authority information of Mr. A is determined by querying the mapping relation.

It should be noted that under the premise that evaluation parameters other than the author authority information, such as the demand intensity information and the scarcity degree information of the knowledge content, are constant, the greater the author authority information of the knowledge content input into the evaluation model, the larger the evaluation value of the knowledge content is.

For example, under the premise that the demand intensity information and the scarcity degree information of the knowledge content are constant, it is detected that both Mr. A and Mr. B publish a file about New Explanation on the Analects of Confucius, author authority information of Mr. A is a, author authority information of Mr. B is b. If a is greater than b, an evaluation value of the file published by Mr. A is greater than an evaluation value of the file published by Mr. B.

At block S203, scarcity degree information of the knowledge content is obtained.

In an embodiment of the present disclosure, the scarcity degree information of the knowledge content may be obtained as follows. A subject of the knowledge content is obtained. The number of knowledge contents corresponding to the subject is obtained. The scarcity degree information of the knowledge content is determined according to the number of the knowledge contents corresponding to the subject.

It should be noted that, in an embodiment of the present disclosure, a mapping relation between the scarcity degree information of the knowledge content and the number of knowledge contents corresponding to the subject of the knowledge content may be preset. After obtaining the number of the knowledge contents corresponding to the subject of the knowledge content, the scarcity degree information of the knowledge content may be obtained by querying the mapping relation.

For example, when evaluating New Explanation on the Analects of Confucius written by Mr. A and published on a certain thesis database B, a subject of the file is obtained and recorded as the Analects of Confucius, the number of knowledge contents corresponding to the recorded subject is obtained, then the scarcity degree information of the file New Explanation on the Analects of Confucius of Mr. A is determined by querying the mapping relation.

It should be noted that, under the premise that evaluation parameters other than the scarcity degree information, such as the demand intensity information and the author authority information of the knowledge content, are constant, the greater the scarcity degree information of the knowledge content input into the evaluation model, the larger the evaluation value of the knowledge content is.

For example, under the premise that the demand intensity information and the author authority information of the knowledge content are constant, it is detected that Mr. A publishes two files New Explanation on the Analects of Confucius and Political Gains and Losses in Past Dynasties of China, the scarcity degree information of the two files are c and d respectively. If c is less than d, an evaluation value of the file New Explanation on the Analects of Confucius published by Mr. A is less than an evaluation value of the file Political Gains and Losses in Past Dynasties of China published by Mr. A.

At block S204, demand intensity information of the knowledge content is obtained.

In an embodiment of the present disclosure, the demand intensity information of the knowledge content may be obtained as follows. A subject of the knowledge content is obtained. A demand intensity parameter of at least one knowledge content corresponding to the subject is obtained. The demand intensity information of the knowledge content is determined according to the demand intensity parameter.

It should be noted that, in an embodiment of the present disclosure, a mapping relation between the demand intensity information of the knowledge content and the demand intensity parameter of the knowledge content corresponding to the subject of the knowledge content may be preset. After obtaining the demand intensity parameter of the knowledge content corresponding to the subject of the knowledge content, the demand intensity information of the knowledge content may be obtained by querying the mapping relation.

The demand intensity parameter includes at least one of a retrieval volume, a usage volume, a usage duration and click rate data of the at least one knowledge content.

For example, when evaluating New Explanation on the Analects of Confucius written by Mr. A) and published on a certain thesis database B, a subject of the file may be obtained and recorded as the Analects of Confucius, and then a retrieval volume and click rate data of the knowledge content corresponding to the subject are obtained to determine the demand intensity parameter of the knowledge content corresponding to the subject the Analects of Confucius. Further, the demand intensity information of New Explanation on the Analects of Confucius is obtained by querying the mapping relation based on the demand intensity parameter.

It should be noted that, under a premise that evaluation parameters other than the demand intensity information, such as the scarcity degree information and the author authority information of the knowledge content, are constant, the greater the demand intensity information of the knowledge content input into the evaluation model, the larger the evaluation value of the knowledge content is.

For example, under the premise that the scarcity degree information of the knowledge content and the author authority information of the knowledge content are constant, it is detected that Mr. A publishes two files Outline of national history and Political Gains and Losses in Past Dynasties of China, the demand intensity information of the two files are e and f respectively. If e is greater than f, an evaluation value of the file Outline of national history published by Mr. A is greater than an evaluation value of the file Political Gains and Losses in Past Dynasties of China published by Mr. A.

It should be noted that, in order to improve the accuracy of the evaluation value of the knowledge content, in an embodiment of the present disclosure, when obtaining the evaluation parameter of the knowledge content, the evaluation parameter may be expanded based on the parameters described above, i.e., the demand intensity information, the author authority information and the scarcity degree information of the knowledge content.

In an embodiment of the present disclosure, after the demand intensity information, the author authority information and the scarcity degree information of the knowledge content are obtained, at least one of following evaluation parameters may be further obtained: length information, a historical sales volume, a score, popularity and information richness of the knowledge content.

When obtaining the length information of the knowledge content, in order to facilitate identification of the length information, a time period taken by the user to completely view the knowledge content is obtained, and the time period is labeled as a multiple of a preset unit time length t. For example, author A publishes a video about basic teaching in Spanish, it takes a user 23 minutes to view the video completely, and the preset t is 10 minutes, then the length information of the video is 2.3t.

It should be noted that, if the knowledge content is a pure text content such as a document, the time period taken by the user to fully view the knowledge content is determined based on an average reading speed of normal users, and the time period is labeled as a multiple of the preset unit time length t. For example, author C publishes a document about basic teaching in Spanish, and the document contains 2000 words in total, the average reading speed of normal users is 200 words per minute, and the preset t is 10 minutes, then the length information of the document is t.

It should be noted that, under a premise that evaluation parameters other than the length information are constant, the longer the length information of the knowledge content input into the evaluation model, the larger the generated evaluation value of the knowledge content is. For example, under the premise that evaluation parameters other than the length information are constant, an evaluation value of a document containing 2000 characters is greater than an evaluation value of a document containing 1000 characters.

When obtaining the historical sales volume of the knowledge content, in order to obtain more accurate and comprehensive historical sales volume information, a historical sales volume of an author of the knowledge content, a historical sales volume of a publisher of the knowledge content, and a historical sales volume of the knowledge content in all versions are obtained. Then, the historical sales volume of the knowledge content is determined by performing algorithms such as average value calculation and weight calculation on the obtained historical sales volumes. The calculation method of the historical sales volume is only a specific example, and the present disclosure does not limit the calculation method of the historical sales volume, which may be set according to actual conditions.

For example, when obtaining a historical sales volume of the second edition of Political Gains and Losses in Past Dynasties of China written by Mr. A and published by China Finance Publishing House, a historical sales volume of all works of Mr. A, also called as a historical sales volume of Mr. A, is 10 million copies, a historical sales volume of China Finance Publishing House is 30 million copies, and a historical sales volume of the first edition of Political Gains and Losses in Past Dynasties of China is 5 million copies, and weights of the historical sales volume of the author of the knowledge content, the historical sales volume of the publisher, and the historical sales volume of all editions are 0.5, 0.2, and 0.3 respectively. It is determined that the historical sales volume of the second edition of Political Gains and Losses in Past Dynasties of China is 12.5 million copies by performing weight calculation based on the above obtained historical sales volumes and corresponding weights.

It should be noted that, under a premise that evaluation parameters other than the historical sales volume are constant, the larger the historical sales volume of the knowledge content input into the evaluation model, the larger the generated evaluation value of the knowledge content is. For example, under the premise that evaluation parameters other than the historical sales volume are constant, an evaluation value of a book with a historical sales volume of 20 million copies is greater than an evaluation value of a book with a historical sales volume of 10 million copies.

When obtaining the score of the knowledge content, in order to obtain more accurate score information, the number of times that the knowledge content is scored and a historical score of the knowledge content are obtained, and then a score of the knowledge content is determined by performing algorithms such as the average value calculation and weight calculation on the number of times and the historical score. The method for calculating the score is only a specific example, and the present disclosure does not limit the calculation method of the score, which may be set according to actual conditions.

For example, when obtaining a score of Political Gains and Losses in Past Dynasties of China written by Mr. A, it is obtained that the number of times of scoring the book is 12,500, and a historical score is 4.9 points (out of 5 points). Weight coefficients of the number of times of scoring the book and the historical score are 0.3 and 0.7 respectively, then the score of the book is determined to be 12.5 million based on the weight calculation.

It should be noted that, in order to improve the accuracy of the score of the knowledge content, the number of times of commenting the knowledge content, the number of times commenting with more than 30 words, and the number of times commenting with a picture may also be obtained, to determine the score of the knowledge content through weight calculation.

It should be noted that, under a premise that evaluation parameters other than the score of the knowledge content are constant, the larger the score of the knowledge content input into the evaluation model, the larger the generated evaluation value of the knowledge content is. For example, under the premise that evaluation parameters other than the score of the knowledge content are constant, an evaluation value of a video with a score of 4.8 is greater than an evaluation value of a video with a score of 4.2.

When obtaining the popularity of the knowledge content, keywords of the knowledge content and/or the number of retrieval times of an author of the knowledge content at a search terminal may be obtained, and then a preset mapping relation between the number of retrieval times and the popularity is queried to determine the popularity of the knowledge content.

For example, when obtaining a popularity of book Political Gains and Losses in Past Dynasties of China written by Mr. A, the number of retrieval times of the keywords of the book such as “china”, “political” and Mr. A are obtained, and the popularity of the knowledge content is determined through querying the mapping relation.

It should be noted that, under a premise that evaluation parameters other than popularity are constant, the larger the popularity of the knowledge content input into the evaluation model, the larger the generated evaluation value of the knowledge content is. For example, under the premise that evaluation parameters other than popularity are constant, the number of retrieval times of “novel coronavirus” is far greater than the number of retrieval times of common bacteria during outbreak of novel coronavirus. At this time, an evaluation value of a paid question and answer about novel coronavirus is greater than an evaluation value of the paid question and answer about common bacteria.

When obtaining information richness of the knowledge content, knowledge-type keywords of the knowledge content may be extracted, and a complexity is obtained by calculating its eigenvector, and then the information richness of the knowledge content is determined by querying a preset mapping relation between the complexity and the information richness.

For example, when obtaining an information richness of Political Gains and Losses in Past Dynasties of China written by Mr. A, knowledge-type keywords of the book may be extracted, and a complexity is obtained by calculating an its eigenvector, and the information richness of the book is determined through querying the mapping relation.

It should be noted that, under a premise that evaluation parameters other than the information richness are constant, the greater the information richness of the knowledge content input into the evaluation model, the larger the generated evaluation value of the knowledge content is. For example, under the premise that evaluation parameters other than the information richness are constant, an information richness of a book about simultaneous interpretation teaching is greater than an information richness of a book about primary teaching on pinyin for children. Therefore, an evaluation value of the book about simultaneous interpretation teaching is greater than an evaluation value of the book about primary pinyin teaching on for children.

It should be noted that, on the basis of the above evaluation parameters, other evaluation parameters such as a user attribute may be added according to actual conditions to further improve the accuracy of the evaluation value.

At block S205, an evaluation value of the knowledge content is generated according to the evaluation parameter.

The action at block S205 is the same as the action at block S103 in the previous embodiment, which will not be repeated herein.

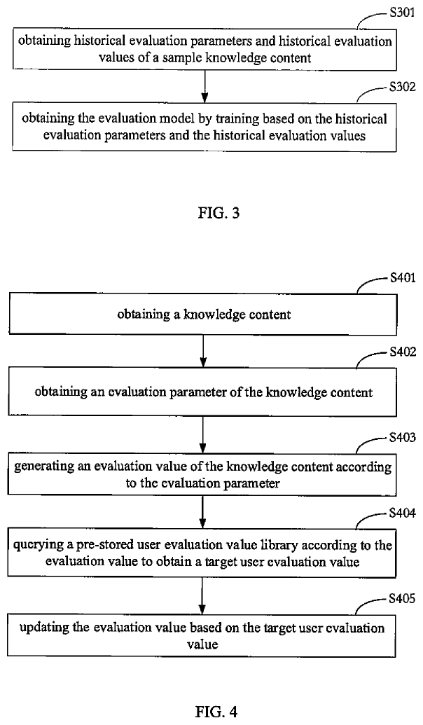

It should be noted that, the evaluation model is pre-trained. In an embodiment of the present disclosure, as illustrated in FIG. 3, the evaluation model may be established in advance as follows.

At block S301, historical evaluation parameters and historical evaluation values of a sample knowledge content are obtained.

The historical evaluation parameters and the historical evaluation values of the sample knowledge content may be collected in advance. The number of the sample knowledge contents may preset, for example, the historical evaluation parameters and the historical evaluation values of 100 sample knowledge contents may be obtained.

At block S302, an evaluation model is obtained by training based on the historical evaluation parameters and the historical evaluation values.

In an embodiment of the present disclosure, when training the evaluation model based on the historical evaluation parameters and the historical evaluation values, the historical evaluation parameters and the historical evaluation values may be substituted into a multivariate equation for calculation. For example, the multivariate equation may be an n-variable linear equation Y=a1x1+a2x2+ . . . anxn, and a weight value corresponding to each historical evaluation parameter in the multivariate equation is obtained through the calculation. Y represents a historical evaluation value, x1, . . . , xn represent multiple historical evaluation parameters, and a1, . . . , an represent weight values corresponding to the historical evaluation parameters.

Further, the evaluation model may be obtained based on the weight values and the multivariate equation.

For example, the historical evaluation parameters and the historical evaluation values are substituted into the multivariate equation for training, and the weight values corresponding to respective evaluation parameters in the multivariate equation are obtained as follows. The demand intensity information D of the knowledge content corresponds to a weight value k1. The author authority information F of the knowledge content corresponds to a weight value k2. The scarcity degree information R of the knowledge content corresponding to a weight value k3. At this time, the evaluation model may be obtained based on the weight values and the multivariate equation as: F(P)=D*k1+F*k2+R*k3, where F(P) is the evaluation value of the knowledge content.

It should be noted that, when the historical evaluation parameters and the historical evaluation values are substituted into the multivariate equation for training, an average value of the historical evaluation parameter of other sample knowledge contents for training is determined as the historical evaluation parameter of the sample knowledge content in response to a missing of the historical evaluation parameter of the sample knowledge content, to ensure that the evaluation model is trainable and expected to be able to converge.

It should be noted that, when evaluation parameters of the current knowledge content to be evaluated is input into the evaluation model to generate an evaluation value, if a value of an evaluation parameter of the knowledge content to be evaluated is missing, values of the evaluation parameter of the sample knowledge contents for training the evaluation model may be obtained, and then an average value of the values of the evaluation parameter of the sample knowledge contents is obtained and determined as the value of the evaluation parameter of the knowledge content.

In some embodiments of the present disclosure, based on the historical evaluation parameters and the historical evaluation values, model training is performed on the above model design until it converges, thus a trained evaluation model is obtained.

It should be noted that, at a model level, the historical evaluation parameters and the historical evaluation values involved in training of the evaluation model in the present disclosure are a relatively closed collection. As long as preliminary data is sufficiently prepared, the collection of the historical evaluation parameters and the historical evaluation parameters are a relatively complete collection, thus ensuring completeness of the historical evaluation parameters and the historical evaluation values. For the feasibility of model training, physical meaning and dependence of the input and output of each step in the model are clear, and a large number of mature solutions are available for modeling the dependence, so the model is trainable and is expected to be able to converge.

With the method for evaluating a knowledge content according to the embodiments of the present disclosure, the historical evaluation parameters and the historical evaluation values of the sample knowledge content are obtained in advance, and a complete and convergent evaluation model is obtained by training. Therefore, after obtaining the demand intensity information, the author authority information and the scarcity degree information of the knowledge content, and the evaluation parameter including at least one of the length information, the historical sales volume, the score, the popularity and information richness of the knowledge content, the evaluation parameter is input into the evaluation model to generate the evaluation value of the knowledge content to be evaluated, which not only avoids the technical problem of excessive subjectivity in evaluating the knowledge content, but also reduces a deviation of the evaluation value of the knowledge content by obtaining the evaluation value of the knowledge content based on a reasonable reference system, so that the rationality and accuracy of the evaluation value is improved.

It should be noted that, after obtaining the evaluation value of the knowledge content according to the evaluation parameter, each knowledge content may have an estimated initial evaluation value. In the present disclosure, in order to improve the accuracy of the evaluation value of the knowledge content, the obtained initial evaluation value may be reasonably adjusted to determine an updated evaluation value.

As a possible implementation, as illustrated in FIG. 4, on the basis of the embodiment illustrated in FIG. 1, the method for evaluating a knowledge content according to the present disclosure includes the following actions.

At block S401, a knowledge content is obtained.

The action at block S401 is the same as the action at block S101 in the embodiment illustrated in FIG. 1, which will not be repeated herein.

At block S402, an evaluation parameter of the knowledge content is obtained.

The evaluation parameter includes demand intensity information, author authority information, and scarcity degree information of the knowledge content, and at least one of length information, a historical sales volume, a score, popularity and information richness of the knowledge content.

At block S403, an evaluation value of the knowledge content is generated according to the evaluation parameter.

The action at block S403 is the same as the action at block S103 in the embodiment illustrated in FIG. 1, which will not be repeated herein.

The evaluation value is an initial evaluation value of the knowledge content, and the initial evaluation value may be adjusted through the actions at blocks S404 to S405 to obtain an updated evaluation value of the knowledge content.

At block S404, a pre-stored user evaluation value library is queried according to the evaluation value to obtain a target user evaluation value.

For example, the evaluation value is a price. Then the pre-stored user evaluation value library is equivalent to a preset consumer price library in which a plurality of consumer prices are distributed in an arithmetic sequence. In practical applications, the prices stored in the library are generally integer prices ending with 9, or prices ending with 0.99. The price is set with upper and lower limits, such as, 0.99-9999 yuan. For example, the consumer price library includes 9, 19, 29, 39, . . . 99 yuan and other consumer prices.

In an embodiment of the present disclosure, the target user evaluation value may be obtained by querying the pre-stored user evaluation value library according to the evaluation value.

For example, an evaluation value, i.e., an initial evaluation value of Political Gains and Losses in Past Dynasties of China written by Mr. A is 43.19 yuan, and a consumer price closest to the book obtained by querying the user evaluation value library is obtained as 39 yuan, thus the target user evaluation value of the book is determined to be 39 yuan.

At block S405, the evaluation value is updated based on the target user evaluation value.

It should be noted that, after the target user evaluation value is obtained, for further adjusting, in the present disclosure, the target user evaluation value is updated through online testing to obtain the updated evaluation value.

With the method for evaluating knowledge content according to the embodiments of the present disclosure, after obtaining the evaluation value of the knowledge content, the target user evaluation value is obtained by querying the pre-stored user evaluation value library, and then the evaluation value is updated based on the target user evaluation value to determine the updated evaluation value as the final evaluation value of the knowledge content, so that after the evaluation value is obtained by the evaluation model, the initial evaluation value is updated through the transaction test, thus the final evaluation value of the knowledge content may be more reasonable and closer to the actual market demand, maximizing the sales benefit of the knowledge content.

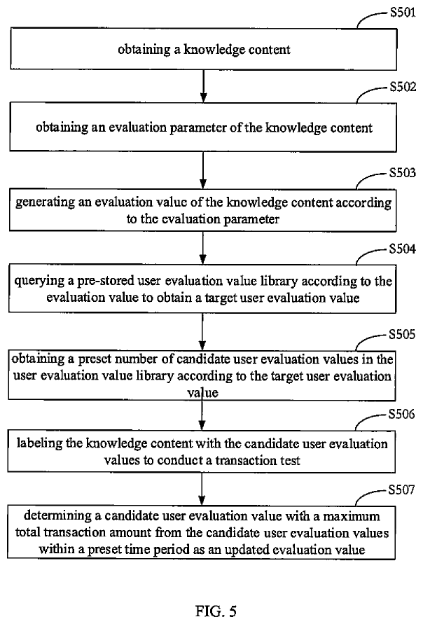

FIG. 5 is a flowchart of a method for evaluating a knowledge content according to an embodiment of the present disclosure. As illustrated in FIG. 5, based on the embodiment illustrated in FIG. 4, the method for evaluating a knowledge content includes the following actions.

At block S501, a knowledge content is obtained.

At block S502, an evaluation parameter of the knowledge content is obtained.

At block S503, an evaluation value of the knowledge content is generated according to the evaluation parameter.

At block S504, a pre-stored user evaluation value library is queried according to the evaluation value to obtain a target user evaluation value.

The actions at blocks S501-S504 are the same as the actions at blocks S401-S404 in the embodiment illustrated in FIG. 4, which will not be repeated herein.

At block S505, a preset number of candidate user evaluation values are obtained in the user evaluation value library according to the target user evaluation value.

In an embodiment of the present disclosure, the preset number of the candidate user evaluation values are obtained by querying the user evaluation value library according to the target user evaluation value. The preset number may be set according to actual conditions. For example, the target user evaluation value may be increased to obtain two candidate user evaluation values larger than the target user evaluation value, and may be decreased to obtain one candidate user evaluation value smaller than the target user evaluation value. At this time, the preset number is 3. It should be noted that, at this time, by adding the obtained target user evaluation value based on the obtained 3 candidate user evaluation values, there are a total of 4 candidate user evaluation values.

For example, if a target user evaluation value of Political Gains and Losses in Past Dynasties of China written by Mr. A is 39 yuan, the number of the target user evaluation value is increased by adding two larger candidate user evaluation values and one smaller candidate user evaluation value to obtain 4 candidate user evaluation values: 29 yuan, 39 yuan, 49 yuan and 59 yuan.

At block S506, the knowledge content is labeled with the candidate user evaluation values to conduct a transaction test.

In an embodiment of the present disclosure, after obtaining the candidate user evaluation values, the knowledge content may be labeled with the candidate user evaluation values respectively, and a transaction test may be performed to obtain the updated evaluation value.

A transaction test method may be set according to actual conditions.

For example, the test is performed by means of A/B testing.

For example, the candidate user evaluation values of Political Gains and Losses in Past Dynasties of China written by Mr. A are 29 yuan, 39 yuan, 49 yuan and 59 yuan. The book may be sold at the above 4 prices respectively, and a total transaction amount corresponding to each of the 4 prices is obtained after the transaction corresponding to the 4 prices are completed. The total transaction amount is a product of a price and a sales amount.

It should be noted that, in order to improve accuracy of the updated evaluation value, homogeneous users may be selected to respectively test different candidate user evaluation values to compare the total transaction values of different groups. The homogenous users refer to users obtained through random sampling, data of the users are the same except for the price.

At block S507, a candidate user evaluation value with a maximum total transaction amount is determined from the candidate user evaluation values within a preset time period as an updated evaluation value.

The obtained evaluation value is the updated evaluation value of the knowledge content, that is, the final evaluation value.

For example, for the Political Gains and Losses in Past Dynasties of China written by Mr. A, the candidate user evaluation values are 29 yuan, 39 yuan, 49 yuan, and 59 yuan, and the sales volumes obtained by selling the books at the 4 different prices within 7 days are 400, 300, 200, and 100 respectively. Thus, corresponding total transaction amounts are 29*400=11600 yuan, 11700 yuan, 9,800 yuan, 5900 yuan. The user evaluation value corresponding to the maximum total transaction amount is determined as the updated evaluation value. That is, the candidate user evaluation value of 39 yuan corresponding to the total transaction amount of 11,700 yuan is determined as the updated evaluation value.

It should be noted that, if there are at least two candidate user evaluation values corresponding to the maximum total transaction amount after the transaction test, a minimum value in the at least two candidate user evaluation values corresponding to the maximum total transaction amount is determined as the updated evaluation value. Alternatively, the knowledge content may be labelled with the at least two candidate user evaluation values corresponding to the maximum total transaction amount and transaction test may be performed again. For example, for the Political Gains and Losses in Past Dynasties of China written by Mr. A, the candidate user evaluation values are 29 yuan, 39 yuan, 49 yuan, and 59 yuan, the sales volumes obtained by selling the books at the 4 different prices are 400, 300, 200, and 100 respectively, and the corresponding total transaction amounts are 11600 yuan, 11600 yuan, 9,800 yuan, 5900 yuan respectively. Then, the book may be labeled with the candidate user evaluation values of 29 yuan and 39 yuan corresponding to the maximum total transaction amount 11600, and the transaction test is performed again.

If there is only one candidate user evaluation value corresponding to the maximum total transaction volume after the transaction test is performed again, the candidate user evaluation value corresponding to the maximum total transaction volume is determined as the updated evaluation value. If there are still at least two candidate user evaluation values corresponding to the maximum total transaction volume after the transaction test is performed again, the minimum evaluation value is selected from the at least two candidate user evaluation values corresponding to the maximum total transaction volume as the updated evaluation value. For example, after the transaction test is performed again, the candidate user evaluation values corresponding to the maximum total transaction amount are 29 yuan and 39 yuan, then 29 yuan is determined as the updated evaluation value.

It should be noted that, in the process of determining the candidate user evaluation value corresponding to the maximum total transaction amount from the at least two candidate user evaluation values within the set time as the updated evaluation value, the total transaction amounts may be compared and labeled based on a first preset time interval. Further, when the number of times that the total transaction amounts are compared reaches a first preset number, the evaluation value of the knowledge content is updated, which not only enables the method for evaluating the knowledge content to be continuously improved, but also avoids frequent fluctuations of the evaluation value on the basis of ensuring that the evaluation value is reasonable.

The first preset time interval and the first preset number of times may be set according to actual conditions. For example, the first preset time interval may be set to 24 hours, and the first preset number of times may be set to 7.

For example, for the Political Gains and Losses in Past Dynasties of China written by Mr. A, the total transaction volume may be counted every 24 hours. When the number of counting times reaches 7, the evaluation value of the knowledge content is updated according to the statistical results.

It should be noted that, the evaluation model may be updated periodically, for example, every month, thus a new evaluation value is obtained according to the updated evaluation model, the target user evaluation value is re-determined according to the new evaluation value, and the transaction test is re-performed according to the target user evaluation value to obtain the final evaluation value.

With the technical solution according to the embodiments of the present disclosure, the knowledge content to be evaluated and the evaluation parameter of the knowledge content are obtained, the evaluation value of the knowledge content is generated according to the obtained evaluation parameter of the knowledge content, the evaluation value is updated according to the target user evaluation value, and the updated evaluation value is determined as the final evaluation value of the knowledge content. Thus, not only the technical problem of excessively subjectivity during evaluating the knowledge content is avoided, but also the deviation of the evaluation value of the knowledge content is reduced as much as possible, so that rationality of the final evaluation value of the knowledge content may be improved and the final evaluation value may be closer to the actual market requirement, thus maximizing the sales benefits of the knowledge content. Furthermore, with the method for evaluating a knowledge content according to embodiments of the present disclosure, a reasonable posterior to the evaluation value of the acquired knowledge content may be performed, so that the evaluation value may be continuously improved in the later stage, and on the basis of ensuring that the evaluation value is reasonable, frequent fluctuation of the evaluation value is avoided.

Corresponding to the method for evaluating a knowledge content according to the above embodiments, an embodiment of the present disclosure also provides an apparatus for evaluating a knowledge content. Since the apparatus for evaluating a knowledge content according to the embodiment of the present disclosure is corresponding to the above method for evaluating a knowledge content according to the above embodiments. The implementation of the method for evaluating a knowledge content is also applicable to the apparatus for evaluating a knowledge content according to this embodiment, which will not be described in detail in this embodiment. FIG. 8 is a schematic diagram of an apparatus for evaluating a knowledge content according to an embodiment of the present disclosure.

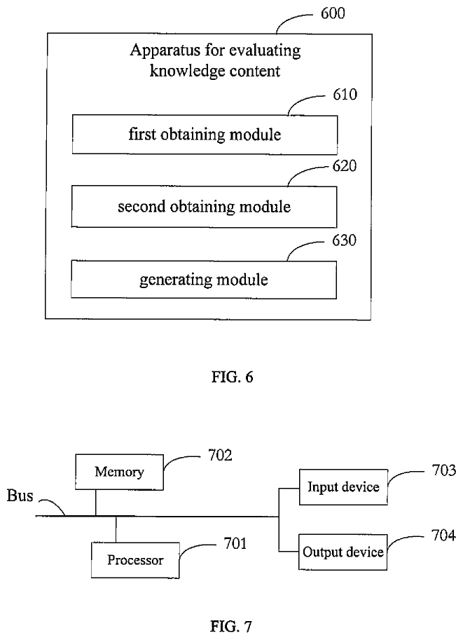

As illustrated in FIG. 6, the apparatus for evaluating a knowledge content 600 includes a first obtaining module 610, a second obtaining module 620 and a generating module 630.

The first obtaining module 610 is configured to obtain a knowledge content.

The second obtaining module 620 is configured to obtain an evaluation parameter of the knowledge content, in which the evaluation parameter includes demand intensity information, author authority information, and scarcity degree information of the knowledge content.

The generating module 630 is configured to generate an evaluation value of the knowledge content according to the evaluation parameter.

In an embodiment, the second obtaining module 620 is configured to: obtain a number of retrieval times of an author of the knowledge content at a search terminal and/or a number of followers on a social media of the author of the knowledge content; and determine the author authority information of the knowledge content according to the number of the retrieval times and/or the number of the followers.

In an embodiment, the second obtaining module 620 is configured to: obtain a subject of the knowledge content; obtain a number of knowledge contents corresponding to the subject; and determine the scarcity degree information of the knowledge content according to the number of the knowledge contents corresponding to the subject.

In an embodiment, the second obtaining module 620 is configured to: obtain a subject of the knowledge content; obtain a demand intensity parameter of at least one knowledge content corresponding to the subject, in which the demand intensity parameter includes at least one of a retrieval volume, a usage volume, a usage duration and click rate data of the at least one knowledge content; and determine the demand intensity information of the knowledge content according to the demand intensity parameter.

In an embodiment, the evaluation parameter further includes at least one of length information, a historical sales volume, a score, popularity and information richness of the knowledge content.

In an embodiment, the generating module 630 is configured to: query a pre-stored user evaluation value library according to the evaluation value to obtain a target user evaluation value; and update the evaluation value based on the target user evaluation value.

In an embodiment, the generating module 630 is configured to: obtain a preset number of candidate user evaluation values in the user evaluation value library according to the target user evaluation value; label the knowledge content with the candidate user evaluation values, and perform a transaction test; and determine a candidate user evaluation value with a maximum total transaction amount from the candidate user evaluation values within a preset time period as an updated evaluation value.

In an embodiment, the generating module 630 is configured to: in response to determining at least two candidate user evaluation values with the maximum total transaction amount, label the knowledge content with the at least two candidate user evaluation values with the maximum total transaction amount and perform the transaction test again.

In an embodiment, the generating module 630 is configured to: in response to determining at least two candidate user evaluation values with the maximum total transaction amount, determine a minimum candidate user evaluation value from the at least two candidate user evaluation values with the maximum total transaction amount as the updated evaluation value.

In an embodiment, the generating module 630 is configured to: input the evaluation parameter into an evaluation model to generate the evaluation value.

In an embodiment, the generating module 630 is configured to: obtain historical evaluation parameters and historical evaluation values of a sample knowledge content; and obtain the evaluation model by training based on the historical evaluation parameters and the historical evaluation values.

In an embodiment, the generating module 630 is configured to: substitute the historical evaluation parameters and the historical evaluation values into a multivariate equation for training, to obtain a weight value corresponding to each evaluation parameter in the multivariate equation, in which the multivariate equation comprises a plurality of evaluation parameters, and a weight value and an evaluation value corresponding to each evaluation parameter; and obtain the evaluation model according to the weight value and the multivariate equation.

In an embodiment, the generating module 630 is configured to: determine an average value of the historical evaluation parameter of other sample knowledge contents for training as the historical evaluation parameter of the sample knowledge content in response to a missing of the historical evaluation parameter of the sample knowledge content.

In an embodiment, the generating module 630 is configured to: in response to a missing of the evaluation parameter of the knowledge content, determine historical evaluation parameters same as the evaluation parameter of the knowledge content from historical evaluation parameters of sample knowledge contents used to train the evaluation model, determine an average value of the historical evaluation parameters same as the evaluation parameter of the knowledge content as the evaluation parameter of the knowledge content.

In the technical method according to embodiments of the present disclosure, the knowledge content and the evaluation parameter of the knowledge content are obtained, and the evaluation value of the knowledge content is generated according to the evaluation parameter of the knowledge content, and then the evaluation value is updated according to the target user evaluation value, and the updated evaluation value is determined as the final evaluation value of the knowledge content, which not only avoids excessive subjectivity in the content knowledge evaluation process, but also reduces the deviation of the evaluation value of the knowledge content as much as possible, so that the final evaluation value of the knowledge content is more reasonable and closer to the actual market requirements, and the sales benefits of the knowledge content are maximized. Furthermore, the method for evaluating knowledge content according to the present disclosure also carries out a reasonable posterior to the evaluation value of the acquired knowledge content, so that the evaluation value is continuously updated in the later stage, and on the basis of ensuring that the evaluation value is reasonable, frequent fluctuation in evaluation values is avoided.

According to the embodiments of the present disclosure, the present disclosure also provides an electronic device and a readable storage medium.

FIG. 7 is a block diagram of an electronic device for implementing the method for evaluating knowledge content according to an embodiment of the present disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the present disclosure described and/or required herein.

As illustrated in FIG. 7, the electronic device includes: one or more processors 701, a memory 702, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 701 is taken as an example in FIG. 7.

The memory 702 is a non-transitory computer-readable storage medium according to the present disclosure. The memory stores instructions executable by at least one processor, so that the at least one processor executes the method according to the present disclosure. The non-transitory computer-readable storage medium of the present disclosure stores computer instructions, which are used to cause a computer to execute the method according to the present disclosure.

As a non-transitory computer-readable storage medium, the memory 702 is configured to store non-transitory software programs, non-transitory computer executable programs and modules, such as program instructions/modules (for example, the first obtaining module 610, the second obtaining module 620, and the generating module 630 shown in FIG. 6) corresponding to the method in the embodiment of the present disclosure. The processor 701 executes various functional applications and data processing of the server by running non-transitory software programs, instructions, and modules stored in the memory 702, that is, implementing the method in the foregoing method embodiments.

The memory 702 may include a storage program area and a storage data area, where the storage program area may store an operating system and application programs required for at least one function. The storage data area may store data created according to the use of the electronic device for implementing the method. In addition, the memory 702 may include a high-speed random access memory, and a non-transitory memory, such as at least one magnetic disk storage device, a flash memory device, or other non-transitory solid-state storage device. In some embodiments, the memory 702 may alternatively include a memory remotely disposed with respect to the processor 701, and these remote memories may be connected to the electronic device for implementing the method through a network. Examples of the above network include, but are not limited to, the Internet, an intranet, a local area network, a mobile communication network, and combinations thereof.

The electronic device for implementing the method may further include: an input device 703 and an output device 704. The processor 701, the memory 702, the input device 703, and the output device 704 may be connected through a bus or in other manners. In FIG. 7, the connection through the bus is taken as an example.

The input device 703 may receive inputted numeric or character information, and generate key signal inputs related to user settings and function control of an electronic device for implementing the method, such as a touch screen, a keypad, a mouse, a trackpad, a touchpad, an indication rod, one or more mouse buttons, trackballs, joysticks and other input devices. The output device 704 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, sound input, or tactile input).

The systems and technologies described herein can be implemented in a computing system that includes background components (for example, a data server), or a computing system that includes middleware components (for example, an application server), or a computing system that includes front-end components (For example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other.

In the technical solution of the present disclosure, the knowledge content to be evaluated and the evaluation parameter of the knowledge content are acquired, and the evaluation value of the knowledge content is generated according to the evaluation parameter of the knowledge content, which not only avoids excessive subjectivity in evaluating the knowledge content, but also reduces a deviation of the evaluation value of the knowledge content, so that the evaluation value is more reasonable and accurate.

It should be understood that the various forms of processes shown above can be used to reorder, add or delete steps. For example, the steps described in the present disclosure could be performed in parallel, sequentially, or in a different order, as long as the desired result of the technical solution disclosed in the present disclosure is achieved, which is not limited herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for evaluating a knowledge content, comprising:
obtaining a knowledge content;
obtaining an evaluation parameter of the knowledge content, wherein the evaluation parameter comprises demand intensity information, author authority information, and scarcity degree information of the knowledge content; and
generating an evaluation value of the knowledge content according to the evaluation parameter.

2. The method according to claim 1, wherein obtaining the author authority information of the knowledge content comprises:
obtaining a number of retrieval times of an author of the knowledge content at a search terminal and/or a number of followers on a social media of the author of the knowledge content; and
determining the author authority information of the knowledge content according to the number of the retrieval times and/or the number of the followers.

3. The method according to claim 1, wherein obtaining the scarcity degree information of the knowledge content comprises:
obtaining a subject of the knowledge content;
obtaining a number of knowledge contents corresponding to the subject; and
determining the scarcity degree information of the knowledge content according to the number of the knowledge contents corresponding to the subject.

4. The method according to claim 1, wherein obtaining the demand intensity information of the knowledge content comprises:
obtaining a subject of the knowledge content;
obtaining a demand intensity parameter of at least one knowledge content corresponding to the subject, wherein the demand intensity parameter comprises at least one of a retrieval volume, a usage volume, a usage duration and click rate data of the at least one knowledge content; and
determining the demand intensity information of the knowledge content according to the demand intensity parameter.

5. The method according to claim 1, wherein the evaluation parameter further comprise at least one of length information, a historical sales volume, a score, popularity and information richness of the knowledge content.

6. The method according to claim 1, further comprising:
querying a pre-stored user evaluation value library according to the evaluation value to obtain a target user evaluation value; and
updating the evaluation value based on the target user evaluation value.

7. The method according to claim 6, wherein the updating the evaluation value based on the target user evaluation value comprises:
obtaining a preset number of candidate user evaluation values in the user evaluation value library according to the target user evaluation value;
labeling the knowledge content with the candidate user evaluation values, and performing a transaction test; and
determining a candidate user evaluation value with a maximum total transaction amount from the candidate user evaluation values within a preset time period as an updated evaluation value.

8. The method according to claim 7, further comprising:
in response to determining at least two candidate user evaluation values with the maximum total transaction amount, labeling the knowledge content with the at least two candidate user evaluation values with the maximum total transaction amount and performing the transaction test again.

9. The method according to claim 7, further comprising:
in response to determining at least two candidate user evaluation values with the maximum total transaction amount, determining a minimum candidate user evaluation value from the at least two candidate user evaluation values with the maximum total transaction amount as the updated evaluation value.

10. The method according to claim 1, wherein the generating the evaluation value of the knowledge content according to the evaluation parameter comprises:
inputting the evaluation parameter into an evaluation model to generate the evaluation value.

11. The method according to claim 10, wherein the evaluation model is obtained by training through following acts:
obtaining historical evaluation parameters and historical evaluation values of a sample knowledge content; and
obtaining the evaluation model by training based on the historical evaluation parameters and the historical evaluation values.

12. The method according to claim 11, wherein obtaining the evaluation model by training based on the historical evaluation parameters and the historical evaluation values comprises:
substituting the historical evaluation parameters and the historical evaluation values into a multivariate equation for training, to obtain a weight value corresponding to each evaluation parameter in the multivariate equation, wherein the multivariate equation comprises a plurality of evaluation parameters, and a weight value and an evaluation value corresponding to each evaluation parameter; and
obtaining the evaluation model according to the weight value and the multivariate equation.

13. The method according to claim 11, further comprising:
determining an average value of the historical evaluation parameter of other sample knowledge contents for training as the historical evaluation parameter of the sample knowledge content in response to a missing of the historical evaluation parameter of the sample knowledge content.

14. The method according to claim 10, further comprising:
in response to a missing of the evaluation parameter of the knowledge content, determining historical evaluation parameters same as the evaluation parameter of the knowledge content from historical evaluation parameters of sample knowledge contents used to train the evaluation model, and determining an average value of the historical evaluation parameters same as the evaluation parameter of the knowledge content as the evaluation parameter of the knowledge content.

15. An electronic device, comprising:
at least one processor; and
a memory communicatively connected to the at least one processor; wherein,
the memory stores instructions executable by the at least one processor, and when the instructions are executed by the at least one processor, the at least one processor is caused to implement a method for evaluating a knowledge content, the method comprising:
obtaining a knowledge content;
obtaining an evaluation parameter of the knowledge content, wherein the evaluation parameter comprises demand intensity information, author authority information, and scarcity degree information of the knowledge content; and
generating an evaluation value of the knowledge content according to the evaluation parameter.

16. The electronic device according to claim 15, wherein obtaining the author authority information of the knowledge content comprises:
obtaining a number of retrieval times of an author of the knowledge content at a search terminal and/or a number of followers on a social media of the author of the knowledge content; and
determining the author authority information of the knowledge content according to the number of the retrieval times and/or the number of the followers.

17. The electronic device according to claim 15, wherein obtaining the scarcity degree information of the knowledge content comprises:
obtaining a subject of the knowledge content;
obtaining a number of knowledge contents corresponding to the subject; and
determining the scarcity degree information of the knowledge content according to the number of the knowledge contents corresponding to the subject.

18. The electronic device according to claim 15, wherein obtaining the demand intensity information of the knowledge content comprises:
obtaining a subject of the knowledge content;
obtaining a demand intensity parameter of at least one knowledge content corresponding to the subject, wherein the demand intensity parameter comprises at least one of a retrieval volume, a usage volume, a usage duration and click rate data of the at least one knowledge content; and
determining the demand intensity information of the knowledge content according to the demand intensity parameter.

19. The electronic device according to claim 15, wherein the evaluation parameter further comprise at least one of length information, a historical sales volume, a score, popularity and information richness of the knowledge content.

20. A non-transitory computer-readable storage medium having computer instructions stored thereon, wherein the computer instructions are used to cause the computer to implement a method for evaluating a knowledge content, the method comprising:
obtaining a knowledge content;
obtaining an evaluation parameter of the knowledge content, wherein the evaluation parameter comprises demand intensity information, author authority information, and scarcity degree information of the knowledge content; and
generating an evaluation value of the knowledge content according to the evaluation parameter.
